(19) United States
(12) Patent Application Publication
(10) Pub. No.: US 2023/0057403 A1
(43) Pub. Date: Feb. 23, 2023

(54) Device and method for adjusting or setting a rolling gap of a two-roll straightening machine for rods and/or profiles

(71) Applicant: SMS group GmbH, Düsseldorf (DE)

(72) Inventors: Jörg LINDBUECHL, Monschau (DE); Heinz-Willi GREUEL, Eschweiler (DE); Elmar MOSTERT, Stolberg (DE); Johannes Jacobus Maria VAN SANTEN, AP Noordhoek (NL); Rolf HAFFNER, Düren (DE)

(73) Assignee: SMS group GmbH, Düsseldorf (DE)

(21) Appl. No.: 17/797,523

(22) PCT Filed: Feb. 1, 2021
(86) PCT No.: PCT/EP2021/052309

§ 371 Date: Aug. 4, 2022

(30) Foreign Application Priority Data
Feb. 6, 2020 (DE) 10 2020 201 477.9

(51) Int. Cl. B21B 37/16

(52) U.S. Cl. CPC B21B 37/16

(57) ABSTRACT

The disclosure relates to a device and a method for adjusting or setting a rolling gap of a two-roll straightening machine for rods and/or profiles.

### TECHNICAL FIELD

The disclosure relates to a device and a method for adjusting or setting a rolling gap of a two-roll straightening machine for rods and/or profiles.

### BACKGROUND

Rods or profiles cool down after hot rolling or after heat treatment, for example on a cooling bed. Due to the unavoidable asymmetrical cooling of the rods or profiles, the rods or profiles distort three-dimensionally and under certain circumstances will form helical geometries. For further use of the rods or profiles in, e.g., a saw for short pieces, sufficient straightness of the rods or profiles is necessary. To ensure this straightness, the rods or profiles are straightened accordingly by cold forming.

Straightening takes place between straightening rolls of a straightening machine, in particular a two-roll straightening machine. The adjustment or setting of the straightening rolls, such as the gap geometry, the distance and the alignment of the straightening rolls relative to each other, determines the local stress introduced into the rod or profile and thus the resulting remaining deformation after straightening.

With a given system configuration with existing straightening rolls, the main open-loop or closed-loop control variable remains the straightening force along with the direction of the straightening force. This is given by the straightening gap and the alignment of the straightening rolls relative to each other in relation to the rod or profile geometry.

Various devices or methods are known from the state of the art for adjusting or setting the straightening rolls relative to each other. A hydraulic system for straightening with a controlled straightening force is known from the patent specification CN 29 30 910 Y. A change in the straightening force for the start of the rod or the end of the rod by reducing the rolling gap force can be taken from CN 100 584 478 C. Here, the alignment of the straightening rolls relative to each other is determined by the type of straightening machine.

A device that makes it possible to cushion impacts occurring on the roll frame during the forming of heavily warped black material can be taken from EP 111 46 82 B1. For this purpose, a floating bearing of the straightening rolls is used in a two-roll straightening machine. Hydraulic cylinders are fitted between the holders of the straightening rolls and the roll frame, which can yield accordingly if the pressure is exceeded. This allows the straightening gap to be opened for a short time and reduces the impact on the roll frame.

An electromechanical system for adjusting or setting a rolling gap is known, for example, from CN 101 791 640 B. Separate hydraulic cylinders lock or unlock the setting mechanism of the rolling gap. The mechanics acting on the rolling gap are then moved by an electric drive and the adjustment or setting of the straightening rolls is changed.

### SUMMARY

The disadvantage of the known system concepts or methods for adjusting or setting the straightening rolls lies in the inertia of the electromechanical settings and/or the lack of access to the open-loop or closed-loop control variables that substantially influence the straightening or the rolling gap. As a result, it is not possible to react to deviations in the incoming rod or profile during the straightening process, or it is possible to react with a delay and possibly insufficiently. This then leads to local surface hardening or cracks in the rod or profile, for example, during over-straightening, that is, the introduction of excessive local stresses. Furthermore, deviations in straightness remain if the local stress introduced by the straightening rolls is not sufficient to achieve permanent deformation.

The object of the invention is to further develop a known device for straightening a rod or profile in such a manner that a rapid change of the rolling gap and the rolling force is made possible by changing the adjustment or setting of the straightening rolls relative to each other during the straightening process. This object of the invention is achieved by a device as claimed and a method as claimed.

### DETAILED DESCRIPTION

A two-roll straightening machine for rods or profiles, in particular a skew rolling straightening machine, includes a roll frame, two adjustable straightening rolls, a measuring device for providing an assessment value arising from an assessment of a rod or a profile, and an open-loop or closed-loop control for an adjustment or setting of the straightening rolls.

Each straightening roll is connected to at least one fully hydraulic drive for changing the adjustment or setting of the straightening rolls, and the straightening forces generated by the straightening process can be transmitted substantially, preferably completely, to the roll frame by the fully hydraulic drive.

Within the present application, “fully hydraulic” means that all adjustments and settings of the respective straightening roll necessary for changing the rolling gap and the rolling force are made by at least one hydraulic drive acting on the straightening roll. If multi-axis adjustments or settings are to be made on a straightening roll, a plurality of hydraulic drives can also be used for adjustment or setting in accordance with the invention.

The hydraulic adjustment or setting of the straightening roll enables a more rapid adjustment of the straightening gap even under load compared to, for example, an electrically driven spindle. In addition, through commercially available systems, a hydraulic cylinder can perform a movement with sufficient accuracy while absorbing the forces required by straightening. In conjunction with pressure accumulators and/or buffer elements, a corresponding hydraulic system is also capable of executing highly dynamic movement patterns.

In accordance with a first preferred embodiment, at least one measuring device is provided for determining a system parameter of the two-roll straightening machine, preferably a straightening force, a current consumption of the straightening drives and torques of the straightening drives. This records the preferred system parameters for a straightening process. Together with an individual rod recording, this enables actual data of a rod or profile, in particular shape and dimensions, to be recorded and thus made available for quality assurance. Such data can then, for example, be part of a basis for modeling the straightening machine.

The system parameters may be recorded online. In this sense, “online” means that the number of recordings is so high and the time intervals of the recordings are so small that a course of the system parameters can be displayed over, for example, a rod length while the straightening process of the rod is running.

Preferably, the measuring device is suitable for providing the assessment value of the rod and/or profile for assessing a diameter, a straightness, a roundness, a wall thickness, a surface defect and/or an internal defect. Such a measuring device can assess the condition of the rod or profile before straightening, or can document a straightening outcome after straightening rolling. The different assessment values represent actual or target values for a rod or profile in a straightening process that are possibly technically relevant. Similar to the system parameters, the determined assessment values can form a basis for a process model, and be used for an open-loop or closed-loop control of the straightening machine.

The provision of the assessment values by the measuring device preferably takes place online. This enables a rapid intervention in the straightening process in the event of unforeseen deviations or errors.

Preferably, at least one measuring device for providing an assessment value arising from the assessment of the rod and/or the profile is arranged in front of the straightening rolls. This makes it possible to measure the deviation of the rod or profile from the target specification and to react by adjusting the rolling gap accordingly. This has a particularly advantageous effect if the forming behavior and/or the necessary settings to obtain an appropriate forming are known. This eliminates, for example, the need for run-in rods, with which the straightening machine is first run with a predefined straightening gap and the rolling gap is adjusted after the straightening outcome has been assessed. It is particularly advantageous if, after the straightening process, a corresponding measuring device additionally records the analog assessment values after straightening. This makes it easy to perform a before/after comparison.

It is preferred if the open-loop or closed-loop control includes a process model having at least one analytical, empirical and/or numerical model for describing the relationship between at least one assessment value and/or at least one system parameter and open-loop or closed-loop control variables for the fully hydraulic drives. By using a process model in the control, known relationships can be included in the open-loop or closed-loop control of the straightening machine. These include, for example, material characteristics, diameter-dependent degrees of formation and/or heat treatment conditions. Furthermore, it is possible to react better and faster to a wear-related change in the calibration of the straightening rolls and/or to a springing of the roll frame under load. With a corresponding design of the open-loop or closed-loop control of the straightening machine, this is possible in the course of straightening a rod.

With a device for straightening having at least two straightening machines following one another in a line, at least one of the straightening machines is designed in accordance with the present disclosure. By combining different property profiles and costs of possible straightening machines, the total system costs of a straightening line can be reduced. For example, pre-straightening can be carried out with a rigid multi-roll straightening machine and then fine straightening can be carried out with a two-roll straightening machine with the rolling gap adjustment in accordance with the invention. Alternatively, by combining several two-roll straightening machines, it is possible to take into account material-related forming limits and set them more accurately.

At least one measuring device for providing assessment values of the rod and/or the profile is arranged at least in front of the first straightening machine and/or between two straightening machines. This allows intermediate values in the overall straightening process to be recorded and used for documentation and/or control of the straightening process.

It is preferred if an overlapping open-loop or closed-loop control of the at least two straightening machines is present in the line and the overlapping open-loop or closed-loop control is connected to the measuring devices for the assessment values and/or the system parameters. This allows, for example, the straightening forces or stress distributions to be balanced across the line, in order to prevent cracking and/or surface hardening.

Furthermore, the object of the disclosure is achieved by a method for adjusting or setting a rolling gap of a two-roll straightening machine for rods or profiles, in particular a skew rolling straightening machine, having a roll frame, two adjustable straightening rolls, a measuring device for providing an assessment value arising from an assessment of a rod or a profile, and an open-loop or closed-loop control system for an adjustment or setting of the straightening rolls relative to each other.

The adjustment or setting of the straightening rolls takes place through the fully hydraulic drive assigned to the respective straightening roll, and the straightening forces generated by the straightening process are substantially transmitted to the roll frame by the fully hydraulic drive. Hydraulic, preferably complete, drives enable rapid and dynamic movement even with high acting loads. Corresponding controls and components for hydraulic systems are freely available on the market and are inexpensive.

It is preferred if a system parameter of the two-roll straightening machine, preferably a straightening force, a current consumption of the straightening drives and a torque of the straightening drives, is determined by at least one measuring device. The recording of the system parameters enables an open-loop or closed-loop control along with overload protection of the individual straightening machine. In particular, by recording the straightening force, a force acting on the rod or profile can be documented. In combination with individual rod recording, this can optimize quality assurance, for example.

Preferably, at least one system parameter is determined online by the measuring device. In this manner, the actual state of the straightening process or the straightening machine can be displayed to a system operator.

Furthermore, it is a preferred embodiment of the method if values arising from the assessment of the rod and/or profile are provided by the measuring device for assessing a diameter, a straightness, a roundness, a wall thickness, a surface defect and/or an internal defect. Depending on the positioning of the measuring device, an initial state or a straightening outcome can be recorded. Both enable the optimization of the open-loop or closed-loop control of the straightening machine along with a quality assurance and modeling of the straightening machine.

The values are provided by the measuring device preferably online. This allows data to be made available to a system operator or an open-loop or closed-loop control in a short period of time.

Furthermore, it is preferred if the provision of values arising from the assessment of the rod and/or the profile by the measuring device takes place at least before the straightening rolls. Based on the values, a system operator can then select corresponding target specifications for the adjustment or setting of the straightening rolls.

It is preferred if the open-loop or closed-loop control prescribes open-loop or closed-loop control variables for the fully hydraulic drives by means of a process model having at least one analytical, empirical and/or numerical model for describing the relationship between at least one assessment value and/or at least one system parameter and open-loop or closed-loop control variables for the fully hydraulic drive. The integration of such models into a control allows system target values adapted to the individual rod to be specified by the open-loop or closed-loop control. This reduces the number of run-in rods or the reaction time in the event of deviations.

In a method for straightening a rod and/or a profile, by means of at least two straightening machines following one another in a line, the rolling gap is set in at least one of the straightening machines in the line in accordance with the present disclosure.

As used in this application, the term “or” is intended to mean an inclusive “or” rather than an exclusive “or”. That is, “A or B” refers to any of “A alone,” “B alone,” and “both A and B” unless specified otherwise or clear from context. The articles “a” and “an” as used in this application should generally be construed to mean “one or more” unless specified otherwise or clear from context to be directed to a singular form.

1.-18. (canceled)

19. A two-roll straightening machine for rods or profiles, in particular a skew rolling straightening machine, comprising:
a roll frame;
two adjustable straightening rolls;
a measuring device for providing an assessment value arising from an assessment of a rod or a profile; and
an open-loop or closed-loop control for an adjustment or setting of the straightening rolls,
wherein each straightening roll is connected to a fully hydraulic drive for changing the adjustment or setting of the straightening rolls relative to each other; and
wherein straightening forces generated by straightening the rod or the profile are substantially transmitted to the roll frame by the fully hydraulic drive.

20. The two-roll straightening machine according to claim 19,
further comprising a further measuring device for determining a system parameter of the two-roll straightening machine,
wherein the system parameter is a straightening force, a current consumption of straightening drives, or a torque of the straightening drives.

21. The two-roll straightening machine according to claim 20,
wherein the system parameter can be determined online by the further measuring device.

22. The two-roll straightening machine according to claim 19,
wherein the measuring device is suitable for providing the assessment value of the rod or the profile for assessing a diameter, a straightness, a roundness, a wall thickness, a surface defect, or an internal defect.

23. The two-roll straightening machine according to claim 22,
wherein provision of the assessment value by the measuring device takes place online.

24. The two-roll straightening machine according to claim 22,
wherein the measuring device is arranged in front of the straightening rolls.

25. The two-roll straightening machine according to claim 20,
wherein the open-loop or closed-loop control contains a process model having an analytical, empirical, or numerical model for describing a relationship between the assessment value or the system parameter and open-loop or closed-loop control variables for the fully hydraulic drives.

26. A device for straightening a rod or a profile, comprising
at least two straightening machines following one another in a line,
wherein at least one of the two straightening machines is the two-roll straightening machine in accordance with claim 20.

27. The device according to claim 26,
wherein the measuring device for providing the assessment value of the rod or the profile is arranged in front of a first of the two straightening machines or between the two straightening machines in the line.

28. The device according to claim 26,
wherein an overlapping open-loop or closed-loop control of the at least two straightening machines is present in the line; and
wherein the overlapping open-loop or closed-loop control is connected with the measuring device or the further measuring device.

29. A method for adjusting or setting a rolling gap of a two-roll straightening machine for rods or profiles, in particular a skew rolling straightening machine, having
a roll frame,
two adjustable straightening rolls,
a measuring device for providing an assessment value arising from an assessment of a rod or a profile, and
an open-loop or closed-loop control system for an adjustment or setting of the straightening rolls relative to each other,
the method comprising:
adjusting or setting the straightening rolls through two fully hydraulic drives, one of the two fully hydraulic drives being assigned to each respective straightening roll; and
substantially transmitting straightening forces generated while straightening the rod or the profile to the roll frame by the fully hydraulic drives.

30. The method according to claim 29,
further comprising determining, by a further measuring device, a system parameter of the two-roll straightening machine, the system parameter being a straightening force, a current consumption of straightening drives, or a torque of the straightening drives.

31. The method according to claim 30,
wherein the system parameter is determined by the further measuring device online.

32. The method according to claim 29,
wherein the assessment value is a diameter, a straightness, a roundness, a wall thickness, a surface defect, or an internal defect.

33. The method according to claim 32,
wherein provision of the assessment value by the measuring device takes place online.

34. The method according to claim 32,
wherein provision of the assessment value takes place in front of the straightening rolls.

35. The method according to claim 30,
wherein the open-loop or closed-loop control comprises a process model with at least one analytical, empirical, or numerical model for describing a relationship between the assessment value or the system parameter and open-loop or closed-loop control variables for the fully hydraulic drives.

36. A method for straightening a rod or a profile, by at least two straightening machines following one another in a line,
wherein a rolling gap in at least one of the at least two straightening machines in the line is set in accordance with claim 29.
